(19) United States
(12) Patent Application Publication
(10) Pub. No.: US 2025/0039159 A1
(43) Pub. Date: Jan. 30, 2025

(54) ENCRYPTION MANAGEMENT TO REDUCE OVER-ENCRYPTION

(71) Applicant: INTERNATIONAL BUSINESS MACHINES CORPORATION, ARMONK, NY (US)

(72) Inventors: Rinkesh I. Bansal, Pune (IN); Vinod A. Valecha, Pune (IN); Sanjay B. Panchal, Mumbai (IN); Chintan Thaker, Pune (IN)

(21) Appl. No.: 18/360,002

(22) Filed: Jul. 27, 2023

(51) Int. Cl. H04L 9/40; H04L 41/22

(52) U.S. Cl. CPC H04L 63/0485; H04L 41/22

(57) ABSTRACT

Described are techniques for encryption management such as a computer-implemented method including generating a data flow diagram for a computational system architecture, where the data flow diagram identifies discrete layers that interact with data in the computational system architecture. The method further includes determining discrete encryption processes occurring on same data in different layers of the data flow diagram. The method further includes eliminating, in at least one component of the computational system architecture, a redundant encryption process, where the redundant encryption process is configured to encrypt the same data as another one of the discrete encryption processes.

### BACKGROUND

The present disclosure relates to data management, and, more specifically, to managing encryption levels for data.

Privacy levels in data management are configured so that viewing sensitive, private, personal, confidential, or other protected data can be limited to authorized users. Further, privacy levels can be implemented, in part, using encryption, which scrambles textual data such that it cannot be understood without being decrypted by one or more decryption keys. However, incorrect privacy levels can cause data to leak outside of a trusted environment.

### SUMMARY

Aspects of the present disclosure are directed toward a computer-implemented method including generating a data flow diagram for a computational system architecture, where the data flow diagram identifies discrete layers that interact with data in the computational system architecture. The method further includes determining discrete encryption processes occurring on same data in different layers of the data flow diagram. The method further includes eliminating, in at least one component of the computational system architecture, a redundant encryption process, where the redundant encryption process is configured to encrypt the same data as another one of the discrete encryption processes.

Additional aspects of the present disclosure are directed to systems and computer program products configured to perform the method described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example encryption management system configured to reduce over-encryption, in accordance with some embodiments of the present disclosure.

FIG. 2 illustrates a diagram of an example encryption dashboard, in accordance with some embodiments of the present disclosure.

FIG. 3 illustrates a flowchart of an example method for encryption management, in accordance with some embodiments of the present disclosure.

FIG. 4A illustrates a flowchart of an example method for determining security controls associated with respective layers in a data flow diagram, in accordance with some embodiments of the present disclosure.

FIG. 4B illustrates a flowchart of an example method for determining a total cost of securing data at each layer, in accordance with some embodiments of the present disclosure.

FIG. 5 illustrates a flowchart of an example method for implementing sufficient encryption in a computational system architecture, in accordance with some embodiments of the present disclosure.

FIG. 6 illustrates a flowchart of an example method for encryption management to reduce over-encryption, in accordance with some embodiments of the present disclosure.

FIG. 7 illustrates a flowchart of an example method for downloading, deploying, metering, and billing usage of encryption management code, in accordance with some embodiments of the present disclosure.

FIG. 8 illustrates a block diagram of an example computing environment, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward data management, and, more specifically, to managing encryption levels for data. While not limited to such applications, embodiments of the present disclosure may be better understood in light of the aforementioned context.

As encryption has become more common and effective at protecting data, one challenge is over-encryption. Over-encryption refers to encrypting the same data multiple times. In other words, the same data can be encrypted at multiple levels within a computational system architecture. For example, a computational system architecture can include application encryption, database and/or tablespace encryption, Operating System (OS) native file system encryption, and/or full disk encryption (e.g., self-encrypting disks), among others. Further, enterprises can utilize more than one of the aforementioned encryption techniques (and/or other techniques) when protecting data, which can result in over-encryption. Over-encryption can create inefficient processing overhead by consuming computational resources at multiple instances to encrypt, store, transmit, and/or decrypt the data without improving the security of the data; hence, the term, “over-encryption.”

Aspects of the present disclosure can overcome the aforementioned challenges by providing a dashboard illustrating a heatmap of discrete encryption processes applied by different aspects of a computational system architecture to the same portions of data. Additionally, aspects of the present disclosure can enable a user to alter encryption policies for certain data to ensure each portion of data meets the encryption policy without over-encrypting (e.g., thereby inefficiently using computational resources) or under-encrypting (e.g., thereby exposing sensitive data).

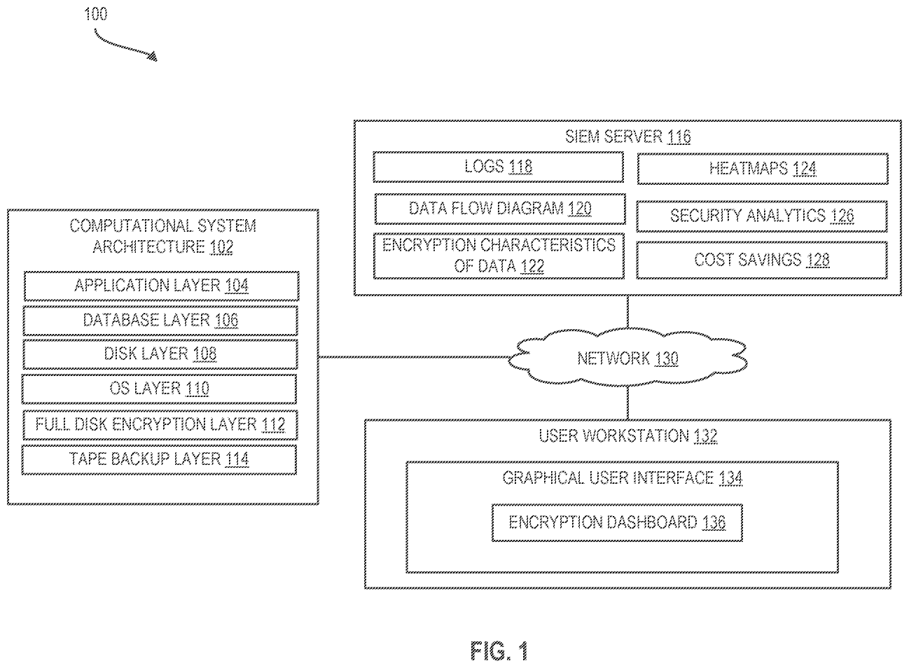

Referring now to the figures, FIG. 1 illustrates a block diagram of an example encryption management system 100 configured to reduce over-encryption, in accordance with some embodiments of the present disclosure. The encryption management system 100 includes computational system architecture 102, SIEM server 116, and user workstation 132 communicatively coupled together via network 130. The network 130 can be a local area network (LAN), a wide area network (WAN), an intranet, the Internet, or any other network 130 or group of networks 130 capable of continuously, semi-continuously, or intermittently connecting (directly or indirectly) the aforementioned components.

Computational system architecture 102 can be a combination of physical and/or virtualized hardware resources (e.g., processing, storage, and network resources), firmware, middleware, and/or software. In some embodiments, computational system architecture 102 is an enterprise-level computational framework and can include tens, hundreds, or thousands of components (e.g., processing components, storage components, and/or networking components). In some embodiments, the computational system architecture 102 can be limited to an individual endpoint.

Each of the SIEM server 116 and user workstation 132 can be realized as a combination of physical and/or virtualized storage resources and/or processing resources. For example, each of the SIEM server 116 and user workstation 132 can be one or more servers, computers desktops, laptops, workstations, mainframes, or another combination of hardware and software.

Computational system architecture 102 can include numerous layers representing an individual or enterprise-grade computational network environment. Various embodiments can include more, fewer, and/or different layers than the layers shown in computational system architecture 102. Computational system architecture 102 can include, for example, application layer 104, database (DB) layer 106, disk layer 108, OS layer 110, full disk encryption layer 112, and tape backup layer 114. Although not explicitly shown, computational system architecture 102 can additionally or alternatively include, for example, a container image layer, a container platform layer, an encryption agent layer, a guest virtual machine layer, an Elastic Sky X (ESX) host server layer, a bare metal infrastructure layer, a local storage layer, a cloud storage layer, and/or other layers. Thus, a variety of layers can exist in any given computational system architecture 102 based on the configuration of the computational system architecture 102 and the characterization criteria used in defining discrete layers.

Application layer 104 can be a layer where data is created and/or processed by software applications. For example, when the application layer 104 includes a web application, the application layer 104 can include a web server, an application server, and/or any middleware.

Database layer 106 can include one or more databases storing data. The database layer 106 can include database management systems (DBMS) (e.g., MySQL®, Oracle® Database, Microsoft® SQL Server, NoSQL, etc.) and any associated tools used for backup and/or recovery operations.

Disk layer 108 can include physical data storage devices such as hard disk drives (HDDs), solid-state drives (SSDs), and the like. In some embodiments, disk layer 108 includes Redundant Array of Independent Disks (RAID) controllers or Storage Area Network (SAN) components that manage disk arrays.

OS layer 110 can include the OS that manages the resources of a given computational architecture. In some embodiments, OS layer 110 provides the interfaces that the software applications use to interact with the hardware. In some embodiments, the OS layer 110 includes device drivers that enable communication between the hardware and the operating system.

Full disk encryption layer 112 can include any encryption software or hardware that is used to encrypt data at rest on a disk. This can include software-based encryption solutions (e.g., BitLocker®, File Vault®, etc.), centralized key managers (e.g., IBM® Guardium® Key Lifecycle Manager (GKLM), etc.), cloud key managers (e.g., Hashicorp® Vault, etc.), and/or hardware-based encryption solutions (e.g., self-encrypting drives (SEDs), hardware security modules (HSMs), etc.).

Tape backup layer 114 includes any backup and recovery solutions that use tape drives or other tape storage media to store backups of data. This can include backup software (e.g., Symantec® NetBackup®, Commvault®, etc.) as well as the tape libraries and drives that are used to store the backups.

SIEM server 116 can collect logs 118 from the computational system architecture 102. Logs 118 can include, for example, event logs, server logs, system logs (e.g., syslogs), transaction logs, message logs, and/or other logs in structured, semi-structured, and/or unstructured format(s).

Additionally, SIEM server 116 can generate a data flow diagram 120 representing the different layers in the computational system architecture 102. The data flow diagram 120 can identify a sequence of processes and/or routines of the computational system architecture, and identify the data inputs to, and data outputs from, each of the processes and/or routines. The data flow diagram 120 can be based on the logs 118, user input, and/or documentation related to the computational system architecture 102. In some embodiments, the data flow diagram 120 is generated, at least in part, using machine learning algorithms and/or natural language processing (NLP).

Further, SIEM server 116 can generate encryption characteristics of data 122 based on the logs 118, data flow diagram 120, and/or other data. Encryption characteristics of data 122 can indicate discrete encryption processes (identified in the logs 118, data flow diagram 120, e.g.) performed on the same data in different layers of the computational system architecture 102.

Also, SIEM server 116 can generate heatmaps 124 that visually indicate an amount and/or type of encryption on respective portions of data in computational system architecture 102. Heatmaps 124 can utilize colors, symbols, graphs, and/or other indicators to visually demonstrate a relative number of discrete encryption processes occurring on different pieces, portions, and/or subsets of data in the computational system architecture 102. In some embodiments, the heatmaps 124 are based, at least in part, on the encryption characteristics of data 122.

SIEM server 116 can further generate security analytics 126 that indicate a robustness of security in different layers, components, and/or elements of the computational system architecture 102. The security analytics 126 can, for example, identify attack vectors and cybersecurity measures associated with each of the layers in the computational system architecture 102 in order to characterize a relative security of data when at use or at rest in different layers of the computational system architecture 102. In some embodiments, the security analytics 126 further characterizes a robustness of encryption on the different pieces, portions, and/or subsets of data in the computational system architecture 102. In some embodiments, the security analytics 126 further characterizes cybersecurity requirements applicable to different pieces, portions, and/or subsets of the data in the computational system architecture 102 and/or for different layers in the computational system architecture 102 (e.g., Health Insurance Portability and Accountability Act (HIPAA), General Data Protection Regulation (GDPR), Payment Card Industry Data Security Standard (PCI DSS), Sarbanes-Oxley (SOX) act regulations, etc.).

Additionally, SIEM server 116 can calculate cost savings 128 associated with removing redundant encryption processes occurring on various pieces, portions, and/or subsets of the data in respective layers of the computational system architecture 102. In some embodiments, the cost savings 128 is based on a size or throughput of data and a computational cost of performing the redundant encryption and/or decryption process per unit data.

User workstation 132 can include a graphical user interface 134. The graphical user interface 134 can present an encryption dashboard 136 including information from the SIEM server 116 such as, for example, data flow diagram 120, encryption characteristics of data 122, heatmaps 124, security analytics 126, and/or cost savings 128. Encryption dashboard 136 can receive user input and modify encryption processes on respective layers in the computational system architecture 102 to reduce over-encryption, thereby increasing computational efficiency.

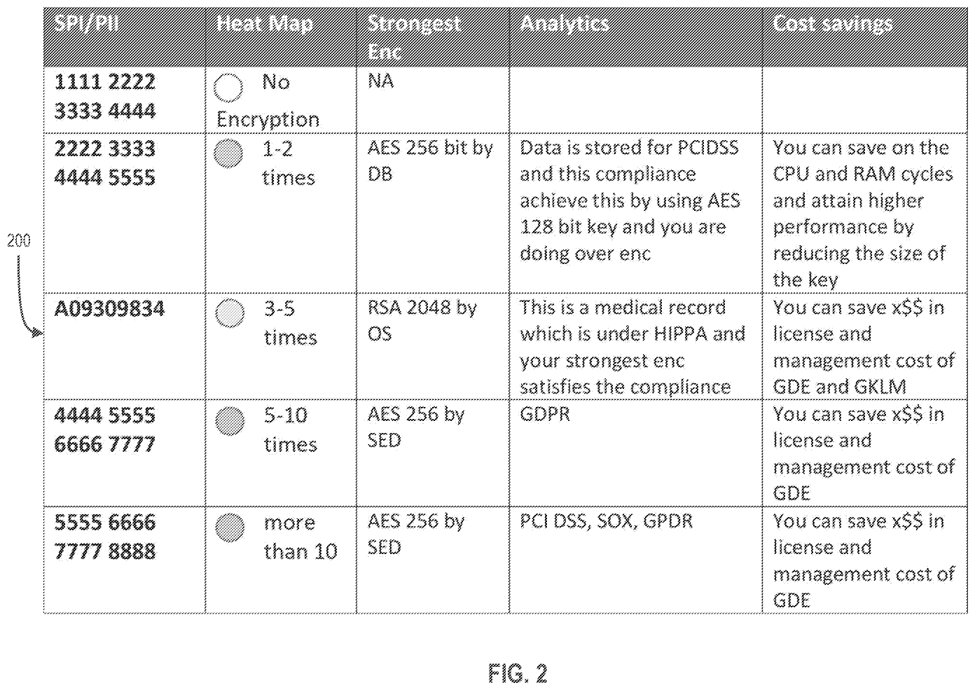

FIG. 2 illustrates a diagram of an example encryption dashboard 200, in accordance with some embodiments of the present disclosure. In some embodiments, encryption dashboard 200 is consistent with encryption dashboard 136 of FIG. 1. Encryption dashboard 200 includes a first column itemizing, in each row, a piece, portion, or subset of data (e.g., sensitive personal information (SPI), personally identifiable information (PII), confidential information, proprietary information, etc.) associated with a computational system architecture. The first column can include an identifier of different portions of data without showing the data itself, thereby preserving the privacy of the data when viewed by an administrator interacting with the encryption dashboard 200.

The encryption dashboard 200 further includes a heatmap column indicating a number of times each row of data is encrypted. In some embodiments, the heatmap column can be based on encryption characteristics of data 122 of FIG. 1 and/or consistent with heatmaps 124 of FIG. 1. The heatmap column can include symbols, graphs, colors, text, and/or other indicators of a number of times the data indicated in each row of the encryption dashboard 200 is encrypted.

The encryption dashboard 200 further includes a strongest encryption column indicating a strongest encryption protocol applied to each row of data. In some embodiments, the strongest encryption column is based on security analytics 126 of FIG. 1.

The encryption dashboard 200 further includes an analytics column providing context for each row of data (e.g., compliance requirements associated with different rows of data, such as, but not limited to, HIPAA, GDPR, PCI DSS, SOX act regulations, etc.). In some embodiments, the analytics column is based on security analytics 126 of FIG. 1.

Encryption dashboard 200 further includes a cost savings column indicating a cost savings realized by reducing redundant encryption processes on various rows of data. Cost savings can be represented monetarily, by processing cycles, storage requirements, network bandwidth, and the like. In some embodiments, the cost savings column is based on cost savings 128 of FIG. 1.

Although not explicitly shown, the encryption dashboard 200 can further include areas capable of receiving user input to implement various measures to the computational system architecture to reduce over-encryption. For example, the encryption dashboard 200 can be configured to include a button with each row of over-encrypted data to enable a user to remove redundant encryption operations to the data and realize the cost savings estimated in the cost savings column.

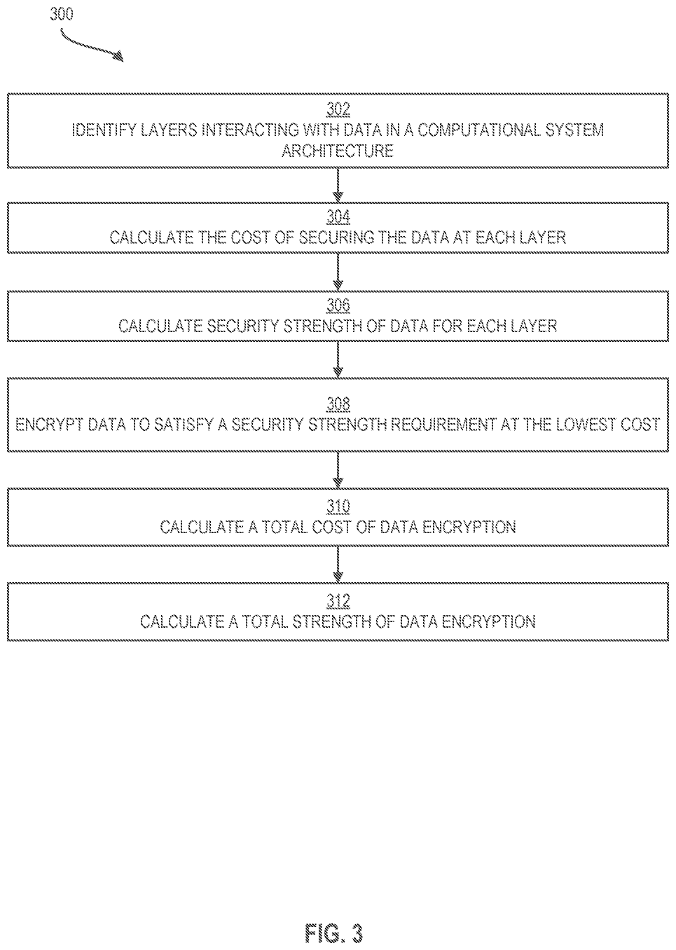

FIG. 3 illustrates a flowchart of an example method 300 for encryption management, in accordance with some embodiments of the present disclosure. The method 300 can be implemented by the encryption management system 100 of FIG. 1, a computer, a processor, one or more processors implementing code stored in a computer-readable storage medium (e.g., computer 801 implementing encryption management code 846), or another combination of hardware and/or software.

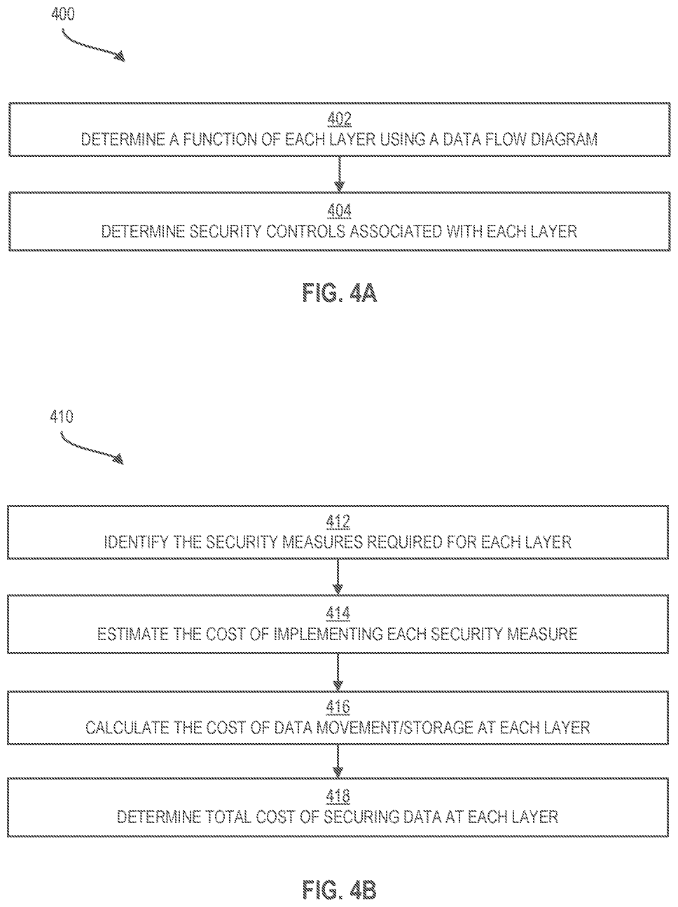

Operation 302 includes identifying layers interacting with data in a computational system architecture. Operation 302 can include evaluating hardware, software, and/or network components that are involved in processing and storing data. The hardware, software, and/or network components can be identified from system architecture information and/or documentation. For example, data can pass through multiple layers such as an application layer, a database layer, a disk layer, an OS layer, a full disk encryption layer, and/or a tape backup layer, among others. Operation 302 is discussed in more detail hereinafter with respect to method 400 of FIG. 4A.

Operation 304 includes calculating the cost of securing the data at each layer. Operation 304 is discussed in more detail hereinafter with respect to method 410 of FIG. 4B.

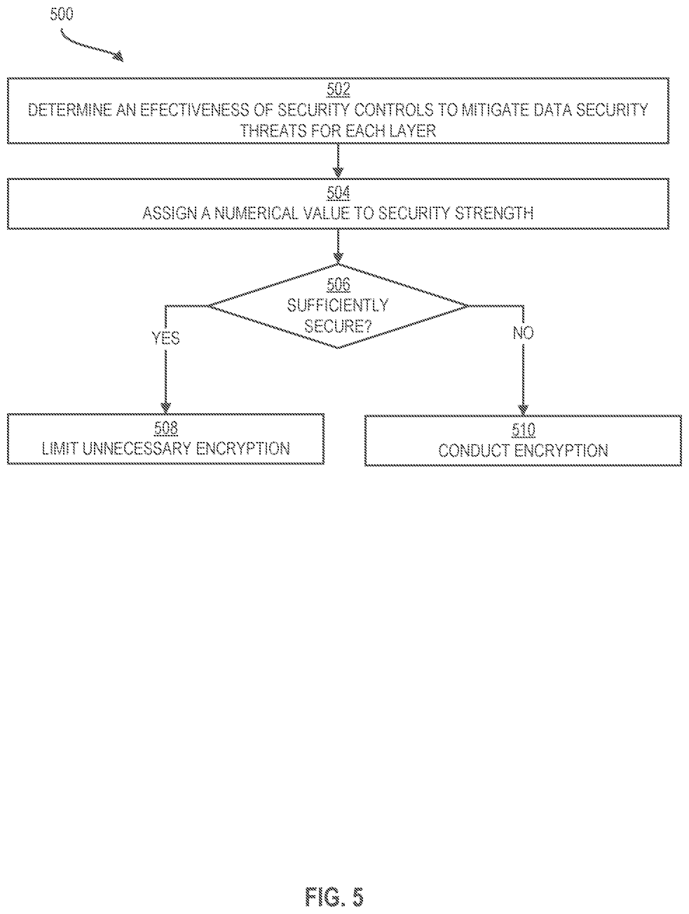

Operation 306 includes calculating a security strength of data for each layer. Operation 306 is discussed in more detail hereinafter with respect to method 500 of FIG. 5.

Operation 308 includes encrypting the data to satisfy a security strength requirement at the lowest identified cost. In some embodiments, the security strength requirement is based on a security strength requirement defined by law or contract (e.g., Service Level Agreement (SLA)). In other embodiments, the security strength requirement is based on best practices or enterprise-defined requirements.

In some embodiments, operation 308 can include removing redundant encryption processes for data where the redundant encryption process provides little, negligible, or a limited improvement in security. In some embodiments, operation 308 can include retaining an existing encryption process to data that would not otherwise satisfy a given security strength requirement. In some embodiments, operation 308 can include adding a new encryption process to data that does not satisfy a given security strength requirement.

Operation 310 includes calculating a total cost of data encryption. Operation 310 can include summing the cost associated with encrypting each portion of the data. Operation 312 includes calculating a total strength of the data encryption. In some embodiments, operation 312 calculates a total strength of the data encryption based on a relatively weakest data encryption protocol applied to otherwise exposed or vulnerable data. In other embodiments, operation 312 calculates a total strength of the data encryption based on a cumulative characterization of all encryption protocols applied to all data throughout the computational system architecture.

FIG. 4A illustrates a flowchart of an example method 400 for determining security controls associated with respective layers in a data flow diagram, in accordance with some embodiments of the present disclosure. The method 400 can be implemented by the encryption management system 100 of FIG. 1, a computer, a processor, one or more processors implementing code stored in a computer-readable storage medium (e.g., computer 801 implementing encryption management code 846), or another combination of hardware and/or software. In some embodiments, the method 400 is a sub-method of operation 302 of FIG. 3.

Operation 402 includes determining a function of each layer using a data flow diagram. Operation 404 includes determining security controls associated with each layer. In some embodiments, operation 402 and/or operation 404 utilizes machine learning and/or NLP to derive a function of each layer from the data flow diagram and/or security controls associated with each layer. In some embodiments, operation 402 and/or operation 404 evaluates logs (e.g., logs 118 of FIG. 1) to determine the function of each layer and/or the security controls associated with each layer.

FIG. 4B illustrates a flowchart of an example method 410 for determining a total cost of securing data at each layer, in accordance with some embodiments of the present disclosure. The method 410 can be implemented by the encryption management system 100 of FIG. 1, a computer, a processor, one or more processors implementing code stored in a computer-readable storage medium (e.g., computer 801 implementing encryption management code 846), or another combination of hardware and/or software. In some embodiments, the method 410 is a sub-method of operation 304 of FIG. 3.

Operation 412 includes identifying the security measures for each layer. For example, an application layer can use authentication and access control measures while a database layer can use encryption and backup measures.

Operation 414 includes estimating the cost of implementing each security measure. For example, the cost of implementing authentication measures can include the cost of purchasing and configuring an identity management solution, while the cost of implementing encryption measures can include the cost of purchasing and deploying encryption software.

Operation 416 includes calculating the cost of data movement and/or storage at each layer. For example, the cost of data storage at the database layer can include the cost of purchasing and maintaining database servers and storage devices.

Operation 418 includes determining a total cost of securing data at each layer. Operation 418 can include adding together individual costs associated with implementing the security measure and data movement and/or storage at each layer.

FIG. 5 illustrates a flowchart of an example method 500 for implementing a sufficient encryption at each layer of a computational system architecture, in accordance with some embodiments of the present disclosure. The method 500 can be implemented by the encryption management system 100 of FIG. 1, a computer, a processor, one or more processors implementing code stored in a computer-readable storage medium (e.g., computer 801 implementing encryption management code 846), or another combination of hardware and/or software. In some embodiments, the method 500 is a sub-method of operations 306 and/or 308 of FIG. 3.

Operation 502 includes determining an effectiveness of security controls to mitigate data security threats for each layer. For example, in an application layer, threats can be malware, social engineering attacks, and/or unauthorized access, among others. Continuing this example, security controls in the application layer can include antivirus software, multi-factor authentication, and/or access controls, among others. Effectiveness of security controls can be determined via penetration testing, vulnerability assessments, and/or other measures.

Operation 504 includes assigning a numerical value to security strength. Operation 504 can generate the numerical value based on the determined effectiveness of the security controls from operation 502.

Operation 506 includes determining whether the data is sufficiently secured. The determination of whether the data is sufficiently secured can be based on a degree to which the security controls are capable of mitigating the security threats.

If so (506: YES), the method 500 proceeds to operation 508 and limits unnecessary additional encryption. In some embodiments, operation 508 includes removing excessive or redundant encryption. If not (506: NO), then the method 500 proceeds to operation 510 and conducts encryption. In some embodiments, operation 510 retains an existing encryption scheme for the data. In other embodiments, operation 510 adds a new encryption scheme to the data.

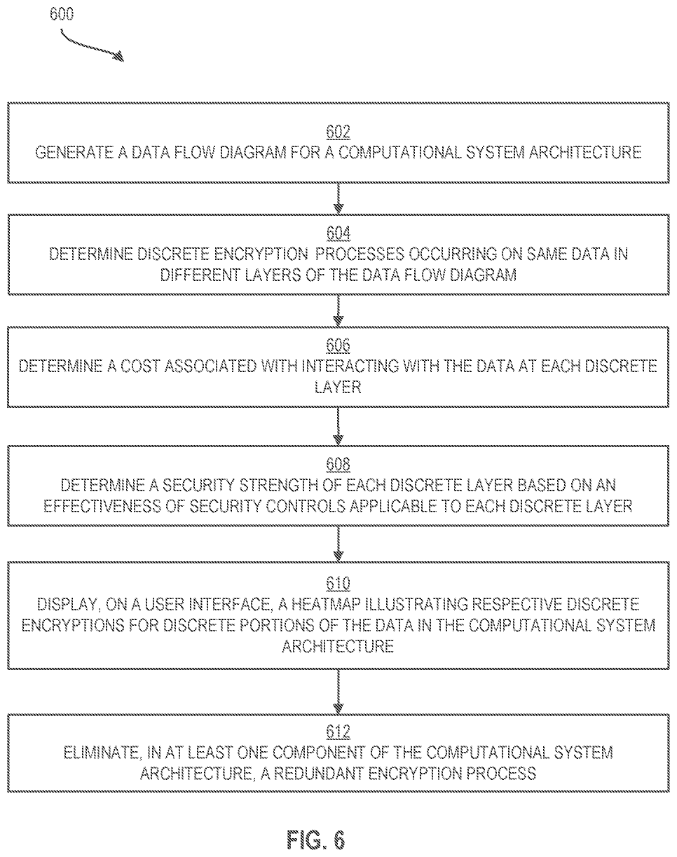

FIG. 6 illustrates a flowchart of an example method 600 for encryption management to avoid over-encryption, in accordance with some embodiments of the present disclosure. The method 600 can be implemented by the encryption management system 100 of FIG. 1, a computer, a processor, one or more processors implementing code stored in a computer-readable storage medium (e.g., computer 801 implementing encryption management code 846), or another combination of hardware and/or software.

Operation 602 includes generating a data flow diagram for a computational system architecture. In some embodiments, the data flow diagram identifies discrete layers that interact with data in the computational system architecture.

Operation 604 includes determining discrete encryption processes occurring on same data in different layers of the data flow diagram. Operation 604 can identify discrete encryption processes from log data collected from the computational system architecture, for example.

Operation 606 includes determining a cost associated with interacting with the data at each discrete layer. In some embodiments, operation 606 determines a monetary cost, computational cost, or other cost associated with encrypting data at each layer.

Operation 608 includes determining a security strength of each discrete layer based on an effectiveness of security controls applicable to each discrete layer.

Operation 610 includes displaying, on a user interface, a heatmap illustrating respective discrete encryptions for discrete portions of the data in the computational system architecture. In some embodiments, the heatmap includes an indication of a strongest encryption protocol implemented on the respective portions of the data having multiple discrete encryptions. In some embodiments, the heatmap includes compliance information for the respective portions of the data. In some embodiments, the heatmap includes estimated cost savings based on eliminating the redundant encryption process. In some embodiments, operation 610 displays an encryption dashboard such as encryption dashboard 136 of FIG. 1 and/or encryption dashboard 200 of FIG. 2.

Operation 612 includes eliminating, in at least one component of the computational system architecture, a redundant encryption process. Operation 612 can be performed automatically or in response to receiving user input (e.g., from an administrator interacting with an encryption dashboard). In some embodiments, the redundant encryption process is associated with a layer having a metric that does not satisfy a threshold, where the metric relates security control effectiveness to the associated cost. In some embodiments, the redundant encryption process is an encryption process performed on data in a first layer where the data has previously been encrypted.

Although not explicitly shown, the method 600 can also include maintaining an encryption process for a second layer where the data is not otherwise encrypted. Likewise, in some embodiments, the method 600 can also include maintaining an encryption process for a second layer where a metric for the second layer satisfies a threshold, where the metric relates security control effectiveness to an associated cost.

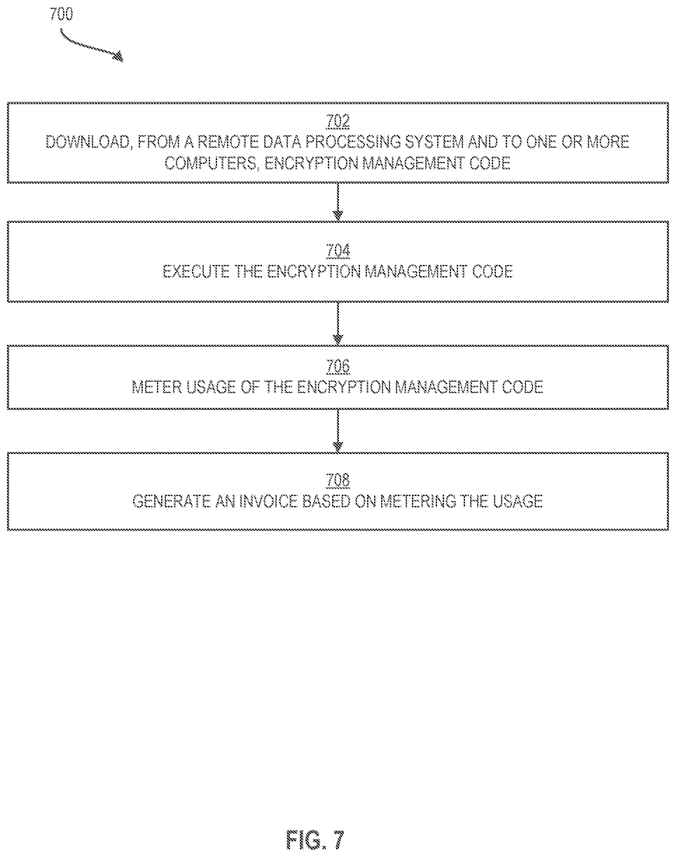

FIG. 7 illustrates a flowchart of an example method 700 for downloading, deploying, metering, and billing usage of encryption management code, in accordance with some embodiments of the present disclosure. The method 700 can be implemented by the encryption management system 100 of FIG. 1, one or more processors implementing code stored in a computer-readable storage medium (e.g., computer 801 implementing encryption management code 846), or another configuration of hardware and/or software. In some embodiments, the method 700 contemporaneously with any of the aforementioned methods.

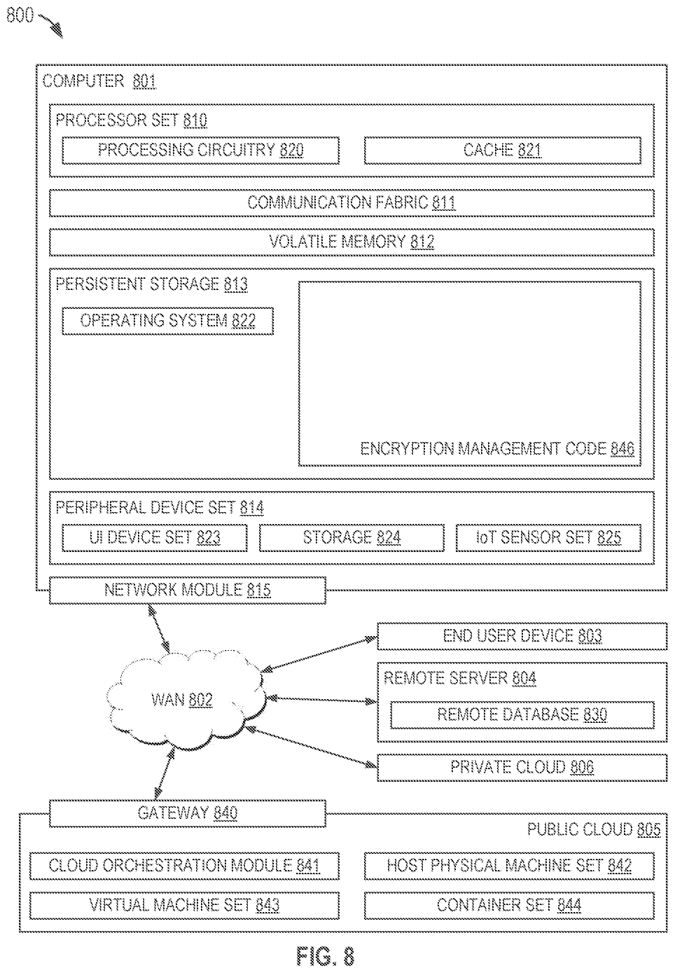

Operation 702 includes downloading, from a remote data processing system and to one or more computers (e.g., SIEM server 116 and/or user workstation 132 of FIG. 1, and/or computer 801 of FIG. 8, etc.) encryption management code (e.g., encryption management code 846 of FIG. 8). Operation 704 includes executing the encryption management code. Operation 704 can include performing any of the methods and/or functionalities discussed herein. Operation 706 includes metering usage of the encryption management code. Usage can be metered by, for example, an amount of time the encryption management code is used, a number of servers, devices, and/or nodes deploying the encryption management code, an amount of resources consumed by implementing the encryption management code, a number encryption implementations modified by implementing the encryption management code (e.g., redundant encryption processes identified and/or removed), and/or other usage metering metrics. Operation 708 includes generating an invoice based on metering the usage.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 8 illustrates a block diagram of an example computing environment, in accordance with some embodiments of the present disclosure. Computing environment 800 contains an example of an environment for the execution of at least some of the computer code involved in performing the inventive methods, such as encryption management code 846. In addition to encryption management code 846, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and encryption management code 846, as identified above), peripheral device set 814 (including user interface (UI), device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in encryption management code 846 in persistent storage 813.

COMMUNICATION FABRIC 811 is the signal conduction paths that allow the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface type operating systems that employ a kernel. The code included in encryption management code 846 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or subset of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any software configured to perform any portion of the methods described previously and/or implement any of the functionalities described previously) can be deployed by manually loading it directly in the client, server, and proxy computers via loading a storage medium such as a CD, DVD, etc., the process software can also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Embodiments of the present invention can also be delivered as part of a service engagement with a client corporation, nonprofit organization, government entity, internal organizational structure, or the like. These embodiments can include configuring a computer system to perform, and deploying software, hardware, and web services that implement, some or all of the methods described herein. These embodiments can also include analyzing the client's operations, creating recommendations responsive to the analysis, building systems that implement subsets of the recommendations, integrating the systems into existing processes and infrastructure, metering use of the systems, allocating expenses to users of the systems, and billing, invoicing (e.g., generating an invoice), or otherwise receiving payment for use of the systems.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

A non-limiting list of examples are provided hereinafter to demonstrate some aspects of the present disclosure. Example 1 is computer-implemented method. The method includes generating a data flow diagram for a computational system architecture, wherein the data flow diagram identifies discrete layers that interact with data in the computational system architecture; determining discrete encryption processes occurring on same data in different layers of the data flow diagram; and eliminating, in at least one component of the computational system architecture, a redundant encryption process, wherein the redundant encryption process is configured to encrypt the same data as another one of the discrete encryption processes.

Example 2 includes the features of Example 1. In this example, the method further comprising: displaying, on a user interface, a heatmap illustrating respective discrete encryptions for discrete portions of the data in the computational system architecture. Optionally, the heatmap includes an indication of a strongest encryption protocol implemented on data having multiple discrete encryptions. Optionally, the heatmap includes compliance information for respective portions of the data. Optionally, the heatmap includes estimated cost savings based on eliminating the redundant encryption process.

Example 3 includes the features of any one of Examples 1 to 2, including or excluding optionally features. In this example, the method further comprising: determining a cost associated with interacting with the data at each discrete layer. Optionally, the method further comprising: determining a security strength of each discrete layer based on an effectiveness of security controls implemented on each discrete layer. Optionally, the redundant encryption process is associated with a layer having a metric that does not satisfy a threshold, wherein the metric relates security control effectiveness to the associated cost.

Example 4 includes the features of any one of Examples 1 to 3, including or excluding optional features. In this example, the redundant encryption process is an encryption process performed on the same data in a first layer, and wherein the same data is encrypted in another discrete layer.

Example 5 includes the features of any one of Examples 1 to 4, including or excluding optional features. In this example, the method further comprising: maintaining an encryption process for a second layer where a portion of the data is not otherwise encrypted.

Example 6 includes the features of any one of Examples 1 to 5, including or excluding optional features. In this example, the method further comprising: maintaining an encryption process for a second layer where a metric for the second layer satisfies a threshold, wherein the metric relates security control effectiveness to an associated cost.

Example 7 includes the features of any one of Examples 1 to 6, including or excluding optional features. In this example, the method is executed by one or more data processing systems based on computer-readable program code downloaded to the one or more data processing systems from a remote data processing system. Optionally, the method further comprises: metering usage of the computer-readable program code; and generating an invoice based on metering the usage of the computer-readable program code.

Example 8 is a system. The system comprises one or more processors; and one or more computer readable storage media comprising program instructions collectively stored on the one or more computer readable storage media, the program instructions comprising instructions configured to cause the one or more processors to perform a method according to any one of Examples 1 to 7, including or excluding optional features.

Example 9 is a computer program product. The computer program product comprises one or more computer readable storage media, and program instructions collectively stored on the one or more computer readable storage media, the program instructions comprising instructions configured to cause one or more processors to perform a method according to any one of Examples 1 to 7, including or excluding optional features.

What is claimed is:

1. A computer-implemented method comprising:
generating a data flow diagram for a computational system architecture, wherein the data flow diagram identifies discrete layers that interact with data in the computational system architecture;
determining discrete encryption processes occurring on same data in different layers of the data flow diagram; and
eliminating, in at least one component of the computational system architecture, a redundant encryption process, wherein the redundant encryption process is configured to encrypt the same data as another one of the discrete encryption processes.

2. The method of claim 1, further comprising:
displaying, on a user interface, a heatmap illustrating respective discrete encryptions for discrete portions of the data in the computational system architecture.

3. The method of claim 2, wherein the heatmap includes an indication of a strongest encryption protocol implemented on data having multiple discrete encryptions.

4. The method of claim 2, wherein the heatmap includes compliance information for respective portions of the data.

5. The method of claim 2, wherein the heatmap includes estimated cost savings based on eliminating the redundant encryption process.

6. The method of claim 1, further comprising:
determining a cost associated with interacting with the data at each discrete layer.

7. The method of claim 6, further comprising:
determining a security strength of each discrete layer based on an effectiveness of security controls implemented on each discrete layer.

8. The method of claim 7, wherein the redundant encryption process is associated with a layer having a metric that does not satisfy a threshold, wherein the metric relates security control effectiveness to the associated cost.

9. The method of claim 1, wherein the redundant encryption process is an encryption process performed on the same data in a first layer, and wherein the same data is encrypted in another discrete layer.

10. The method of claim 1, further comprising:
maintaining an encryption process for a second layer where a portion of the data is not otherwise encrypted.

11. The method of claim 1, further comprising:
maintaining an encryption process for a second layer where a metric for the second layer satisfies a threshold, wherein the metric relates security control effectiveness to an associated cost.

12. The method of claim 1, wherein the method is executed by one or more data processing systems based on computer-readable program code downloaded to the one or more data processing systems from a remote data processing system.

13. The method of claim 12, wherein the method further comprises:
metering usage of the computer-readable program code; and
generating an invoice based on metering the usage of the computer-readable program code.

14. A system comprising:
one or more processors; and
one or more computer readable storage media comprising program instructions collectively stored on the one or more computer readable storage media, the program instructions comprising instructions configured to cause the one or more processors to perform a method comprising:
generating a data flow diagram for a computational system architecture, wherein the data flow diagram identifies discrete layers that interact with data in the computational system architecture;
determining discrete encryption processes occurring on same data in different layers of the data flow diagram; and
eliminating, in at least one component of the computational system architecture, a redundant encryption process, wherein the redundant encryption process is configured to encrypt the same data as another one of the discrete encryption processes.

15. The system of claim 14, wherein the program instructions include further program instructions configured to cause the one or more processors to perform the method further comprising:
displaying, on a user interface, a heatmap illustrating respective discrete encryptions for discrete portions of the data in the computational system architecture.

16. The system of claim 15, wherein the heatmap includes an indication of a strongest encryption protocol implemented on data having multiple discrete encryptions.

17. The system of claim 15, wherein the heatmap includes compliance information for respective portions of the data.

18. The system of claim 15, wherein the heatmap includes estimated cost savings based on eliminating the redundant encryption process.

19. A computer program product comprising one or more computer readable storage media, and program instructions collectively stored on the one or more computer readable storage media, the program instructions comprising instructions configured to cause one or more processors to perform a method comprising:
generating a data flow diagram for a computational system architecture, wherein the data flow diagram identifies discrete layers that interact with data in the computational system architecture;
determining discrete encryption processes occurring on same data in different layers of the data flow diagram; and
eliminating, in at least one component of the computational system architecture, a redundant encryption process, wherein the redundant encryption process is configured to encrypt the same data as another one of the discrete encryption processes.

20. The computer program product of claim 19, wherein the program instructions include further program instructions configured to cause the one or more processors to perform the method further comprising:
displaying, on a user interface, a heatmap illustrating respective discrete encryptions for discrete portions of the data in the computational system architecture.
